(19) United States
(12) Patent Application Publication
(10) Pub. No.: US 2009/0279116 A1
(43) Pub. Date: Nov. 12, 2009

(54) IMAGE DATA PROCESSING APPARATUS

(75) Inventor: Yukihito Nishio, Nara (JP)

Correspondence Address: EDWARDS ANGELL PALMER & DODGE LLP, P.O. BOX 55874, BOSTON, MA, 02205, US

(73) Assignee: SHARP KABUSHIKI KAISHA, Osaka (JP)

(21) Appl. No.: 12/428,635

(22) Filed: Apr. 23, 2009

(30) Foreign Application Priority Data
May 9, 2008 (JP) 2008-123342

(51) Int. Cl. G06F 3/12; G06F 15/00; G06F 17/00

(52) U.S. Cl. 358/1.13; 358/1.15; 715/255; 358/448

(57) ABSTRACT

An image data processing apparatus capable of automatically giving a proper file name based on the similarity of image data is provided. An MFP includes a scanner or communication port that inputs image data, a memory portion having stored thereon comparison data containing a fixed-form format portion (print data or fixed-form format data), together with a file name corresponding to the comparison data, and a CPU that compares a portion equivalent to a fixed-form format portion of comparison data that is contained in image data input by the scanner or the communication port, with a fixed-form format portion of comparison data stored in the memory portion. When the CPU compares image data with comparison data to determine that both data are similar to each other, the CPU sets the file name of the comparison data as the file name of the image data.

### CROSS-NOTING PARAGRAPH

This non-provisional application claims priority under 35 U.S.C. §119(a) on Patent Application No. 2008-123342 filed in JAPAN on May 9, 2008, the entire contents of which are hereby incorporated herein by reference.

### FIELD OF THE INVENTION

The present invention relates to an image data processing apparatus, and, more particularly, to an image data processing apparatus capable of automatically setting a file name for image data input by a scanner, etc.

### BACKGROUND OF THE INVENTION

A digital multifunction peripheral (MFP) having a plurality of functions of copying, printing, faxing, scanning, etc., has been in popular use. Such an MFP usually has a large-capacity memory device, such as a hard disc, and is capable of saving image data read by a scanner and received image data from an information processing apparatus, such as a PC (Personal Computer), as image data with a file name given thereto.

Conventionally, when a file name is given to image data, a user manually inputs the file name to give it to the image data or the MFP automatically acquires a consecutive number to give it as the file name to the image data.

A method of manual input by a user, however, requires the user to input a file name on a keyboard, etc., thus posing a problem of troublesome operation. A method of the MFP automatically giving a consecutive number results in no matching of a file name to image data contents, thus causing inconvenience in execution of image retrieval.

A technique of retrieving a similar image from multiple pieces of image data for efficient image retrieval is known. For example, Japanese Laid-Open Patent Publication No. 2006-338620 describes a technique of comparing the similarity of a pattern with a given value of similarity level and grouping reference image data and image data to be compared based on the result of similarity comparison with the given value.

In many cases, a file name is given to image data as a file name associated with the contents of the image data. When a file name is given to new image data, therefore, if the new image data is a similar image similar to existing image data, the file name given to the new image data as the similar image is assumed to be similar to the file name of the existing image data. In such a case, if the file name of a similar image can be given to new image data, a proper file name according to the contents of image data can be given without manually giving a file name or giving a consecutive number irrelevant to the contents of the image data.

A technical conception like this, however, has not yet been actualized in a conventional technique. The technique described in Japanese Laid-Open Publication No. 2006-338620 discloses only the method of grouping image data captured by a digital camera, etc., based on similarity, and does not disclose the above technical concept of giving a file name based on the similarity of image data.

### SUMMARY OF THE INVENTION

The object of the present invention is to provide an image data processing apparatus capable of automatically giving a proper file name based on the similarity of image data.

Another object of the present invention is to provide an image data processing apparatus comprising: an image input portion that inputs image data; a memory portion that stores therein comparison data containing a fixed-form format portion, together with a file name corresponding to the comparison data; a comparing portion that compares a portion equivalent to a fixed-form format portion of the comparison data contained in image data input by the image input portion, with a fixed-form format portion of comparison data stored in the memory portion; and a file name setting portion that when the comparing portion determines the image data to be similar to the comparison data, sets a file name of the comparison data as a file name of the image data.

Another object of the present invention is to provide the image data processing apparatus, comprising a communication portion that communicates with an external information processing apparatus to receive comparison data including only the fixed-form format portion from the external information processing apparatus, wherein the memory portion stores therein comparison data received by the communication portion, together with a file name of the comparison data.

Another object of the present invention is to provide the image data processing apparatus, comprising a communication portion that communicates with an external information processing apparatus to receive comparison data including a fixed-form format portion and a character data portion from the information processing apparatus, wherein the memory portion stores therein comparison data received by the communication portion, together with a file name of the comparison data.

Another object of the present invention is to provide the image data processing apparatus, comprising a communication portion that communicates with an external memory device having stored thereon comparison data including a fixed-form format portion, wherein the comparison data is periodically downloaded from the external memory device to update comparison data stored in the memory portion.

Another object of the present invention is to provide the image data processing apparatus, wherein the comparing portion compares a portion equivalent to a fixed-form format portion of the comparison data that is contained in image data input by the image input portion, with a fixed-form format portion of comparison data stored in the memory portion, and sets a similarity level representing a level of similarity between the image data and the comparison data, based on a result of the comparison.

Another object of the present invention is to provide the image data processing apparatus, comprising a display portion that displays various data, wherein the display portion displays comparison data of which a similarity level calculated by the comparing portion is equal to or higher than a given value, together with a file name of the comparison data, to allow a user selection.

Another object of the present invention is to provide the image data processing apparatus, wherein the display portion displays thumbnail images of the comparison data in order of higher similarity level calculated by the comparing portion, together with a file name of the comparison data, to allow a user selection.

Another object of the present invention is to provide the image data processing apparatus, wherein when a similarity level calculated by the comparing portion is lower than a given value, a consecutive number in a given format is assigned as a file name to the image data.

Another object of the present invention is to provide the image data processing apparatus, wherein the display portion displays a file name of the image data as a file name that can be edited.

### BRIEF DESCRIPTION OF THE DRAWINGS

FIG. 1 is a block diagram of a configuration example of an image data processing apparatus of the present invention;

FIG. 2 is a diagram of an example of print data of the present invention;

FIG. 3 is a diagram of an example of fixed-form format data of the present invention;

FIGS. 4A to 4C are explanatory diagrams of an example of a process of comparison between image data and comparison data;

FIG. 5 is a flowchart for explaining an example of a file name giving method by an MFP of the present invention;

FIG. 6 is flowchart for explaining another example of the file name giving method by the MFP of the present invention;

FIG. 7 is a diagram of an example of a file name candidate display screen displayed on a display portion; and

FIG. 8 is a diagram of an example of a file name editing screen displayed on the display portion.

### PREFERRED EMBODIMENTS OF THE INVENTION

Preferred embodiments of an image data processing apparatus of the present invention will now be described with reference to the accompanying drawings.

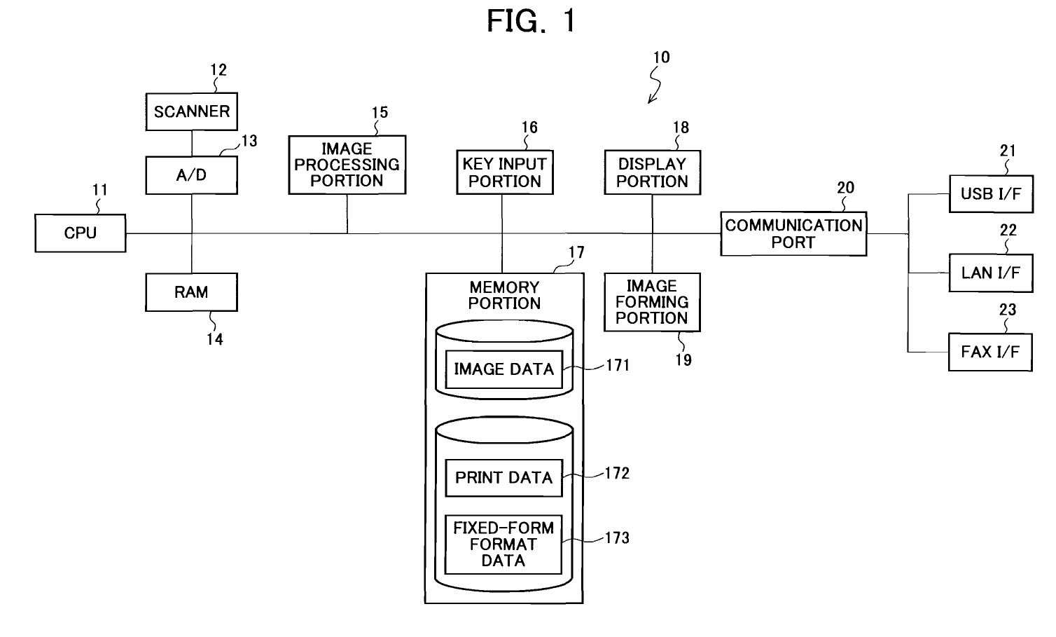

FIG. 1 is a block diagram of a configuration example of an image data processing apparatus according to an embodiment of the present invention. In FIG. 1, 10 denotes the image data processing apparatus (hereinafter “MFP”). The image data processing apparatus 10 includes a CPU 11 that controls the operation of the MFP 10, a scanner 12 that reads a manuscript image to input image data, an A/D converter 13 that subjects an image read by the scanner 12 to A/D conversion, a RAM 14 that is an area for executing various programs, an image processing portion 15 that carries out image processing on image data, a key input portion 16 composed of a group of operating keys and numeric keys, a memory portion 17 having stored thereon image data 171, print data 172, fixed-form format data 173, etc., a display portion 18 that displays various data, an image forming portion 19 serving as a print engine that prints out image data, and a communication port 20 that communicates with external equipment. The memory portion 17 may be provided as a hard disc drive (HDD) or server computer disposed outside the MFP 10 and connected thereto via a network.

The communication port 20 has a USB I/F 21 for detachably connecting various USB (Universal Serial Bus) equipment, a LAN I/F 22 for connecting external equipment, such as PC, via a LAN (local Area Network), and a FAX I/F 23 for connecting a facsimile via such a communication line as the telephone line.

The main feature of the present invention is that comparison data stored in the memory portion 17, such as the print data 172 and fixed-form format data 173, is compared with the image data 171 input by the scanner 12, etc., to give the file name of comparison data similar to the image data 171, to the image data 171 as the file name thereof. In this manner, a file name highly related to the contents of the image data is automatically given.

The MFP 10 has a configuration for achieving the above feature, thus includes the scanner 12 or the communication port 20 equivalent to an image input portion that inputs image data, the memory portion 17, such as a hard disc, that has stored thereon comparison data containing a fixed-form format portion (print data 172 or fixed-form format data 173) together with a file name corresponding to the comparison data, a comparing portion that compares a portion equivalent to the fixed-form format portion of comparison data that is contained in image data input by the scanner 12 or the communication port 20 with the fixed-form format portion of the comparison data stored in the memory portion 17, and a file name setting portion that when the comparing portion determines the image data to be similar to the comparison data, sets the file name of the comparison data as the file name of the image data. The functions of the comparing portion and the file name setting portion are executed by the CPU 11.

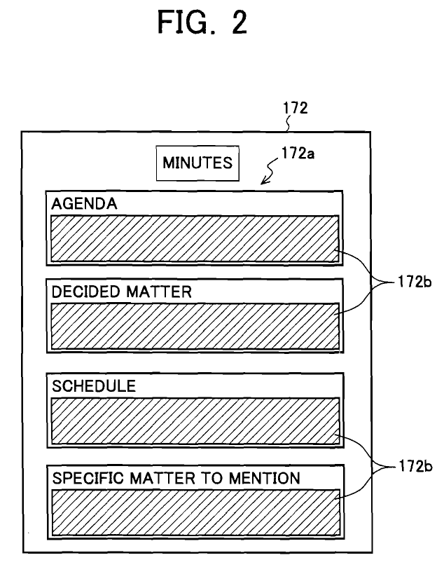

FIG. 2 depicts an example of the print data 172 of the present invention. The print data 172 is made by synthesizing a fixed-form format portion 172a with a character data portion 172b shown in FIG. 2 as a hatched portion. The CPU 11 extracts only the fixed-form format portion 172a from the print data 172, and converts the fixed-form format portion 172a into a bitmap format.

As shown in FIG. 2, the print data 172 is composed of the fixed-form format portion 172a and the character data portion 172b. The print data 172 is received by the communication port 20 as incoming data from an external PC, etc., is stored together with the file name of the print data 172 on the memory portion 17, and is printed out by the image forming portion 19. The print data 172 may be provided as, for example, data of a layer structure. Some of print data transmitted from the external PC to the MFP 10 is layer structure data of which the fixed-form format portion and the character data portion are transmitted separately. When receiving such data, the MFP 10 synthesizes these two portions into print data to print out. In processing the above layer structure data, the CPU 11 is able to easily extract the fixed-form format portion, thus allowed to save the fixed-form format portion as the print data 172.

It is preferable that the print data 172 have a metadata configuration such that the fixed-form format portion is made up of vector data while the other portion is made up of character data.

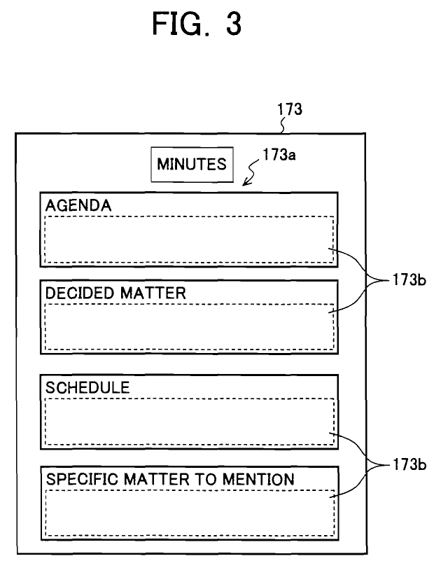

FIG. 3 depicts an example of fixed-form format data 173 of the present invention. The fixed-form format data 173 includes only the fixed-form format portion 173a, that is, does not includes the character data portion that is included in the print data of FIG. 2. The portion corresponding to the character data portion is thus set as a blank portion 173b. The CPU 11 converts the fixed-form format portion 173a of the fixed-form format data 173 into the bitmap format.

As shown in FIG. 3, the fixed-form format data 173 is composed of the fixed-form format portion 173a and the blank portion 173b. The fixed-form format data 173 is received by the communication port 20 as incoming data from an external PC, etc., and is stored together with the file name of the fixed-form format data 173 on the memory portion 17.

The MFP 10 may communicate with an external memory device (file server, etc.) having stored thereon comparison data containing the fixed-form format portion (print data 172 or fixed-form format data 173) via the communication port 20 and periodically (one time a day, etc.) download the comparison data from the external memory device to update the comparison data stored in the memory portion 17. Allowing the MFP 10 to periodically download and update the fixed-form format data eliminates a need of work of manually updating the fixed-form format data.

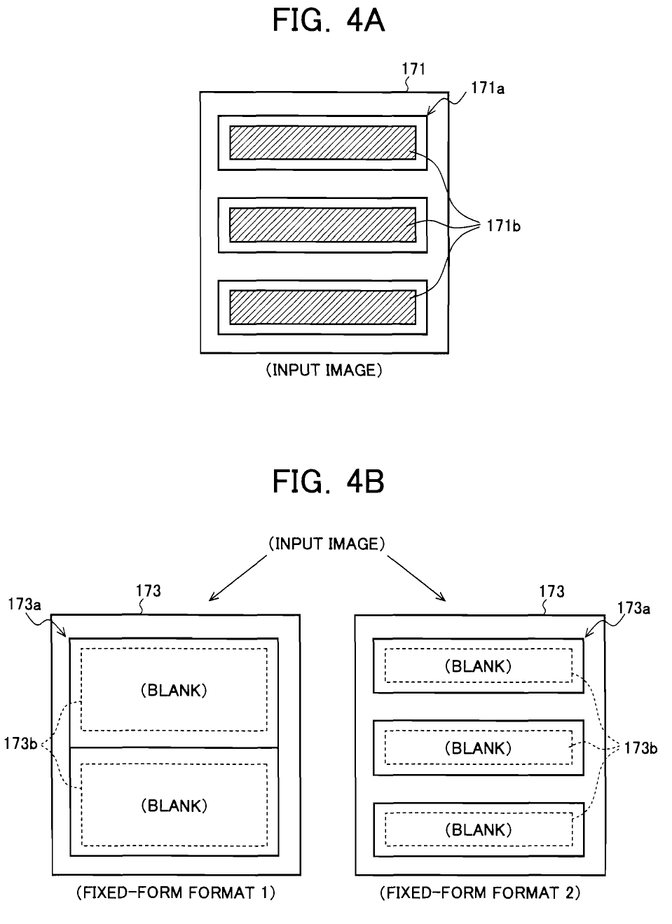

FIGS. 4A to 4C are explanatory diagrams of an example of a process of comparison between the image data 171 and the comparison data. While a process of comparison with the fixed-form format data 173 of FIG. 3 will be described as a typical example, the same comparison process is carried out in a case of comparison with the print data 172. The image data 171 of FIG. 4A is the image data containing a fixed-form format portion, being composed of the fixed-form format portion 171a and a character portion 171b.

As shown in FIG. 4B, two types of format patterns consisting of a fixed-format 1 and a fixed-format 2 are stored in the memory device 17 as the fixed-form format data 173. Each pattern of the fixed-form format data 173 is composed of the fixed-form format portion 173a and the blank portion 173b. The CPU 11 carries out the comparison process on two types of the fixed-form format data 173 by comparing a portion equivalent to the fixed-form format portion 173a of the fixed-form format data 173 that is contained in the image data 171 with the fixed-form format portion 173a of the fixed-form format data 173.

For example, as shown in FIG. 4C, the area in the image data 171 that is equivalent to the blank portion 173b of the fixed format 1 is masked to create a masked image of the image data 171. The area in the image data 171 that is equivalent to the blank portion 173b of the fixed format 2 is also masked to create a masked image of the image data 171. The portion equivalent to the fixed-form format portion 173a of the fixed-form format data 173 in each of the masked images of the image data 171 is thus compared with the fixed-form format portion 173a of the fixed-form format data 173. It is desirable that the above mentioned portion be equivalent to the whole of the fixed-form format portion 173a.

In this example, the CPU 11 carries out pattern matching between each of the above masked images of the image data 171 and each pattern of the fixed-form format data 173 converted into bitmap format data, and determines that the masked image and the fixed-form format data 173 are similar to each other when the ratio of the number of matching pixels to the total number of pixels to be compared is equal to or higher than a given value. In the example of FIGS. 4A to 4C, the fixed-form format 2 is determined to be similar to an input image.

When a plurality of types of the fixed-form format data 173 to be compared are present, the above similarity determining process is executed on each type of the fixed-form format data 173 to determine whether the fixed-form format data 173 is similar to the image data 171.

Documents used in a company, etc., include fixed-form documents made in a plurality of types of fixed-form formats, such as minutes, daily reports, reports, and memos. Comparing fixed-form format portions, therefore, enables giving a proper file name according to the contents of a document. For example, when the fixed-form format portions of image data and comparison data are a format corresponding to “minutes” and the file name of the comparison data is “minutes in April”, the file name “minutes in April” is given to the image data. If the image data is to be saved as minutes in May, the file name “minutes in April” given to the image data is edited into “minutes in May” and is saved as such. As a result, the user does not have to manually input every file name, and is able to give a proper file name without trouble.

The CPU 11 is able to set a similarity level representing a level of the similarity between the image data 171 and the comparison data, based on the result of comparison between the image data 171 input by the scanner 12 or the communication port 20 and the comparison data stored in the memory device 17 (print data 172 or fixed-form format data 173). For example, the CPU 11 carries out pattern matching between the image data and the comparison data, and sets a similarity level based on the ratio of the number of matching pixels to the total number of pixels to be compared. If the ratio of the number of matching pixels is high, the similarity level is set high. If the ratio of the number of matching pixels is low, the similarity level is set low.

When the image data 171 read by the scanner 12 is used, a correction process, such as aligning the image data 171 to the comparison data, should desirably be carried out to improve the precision of pattern matching.

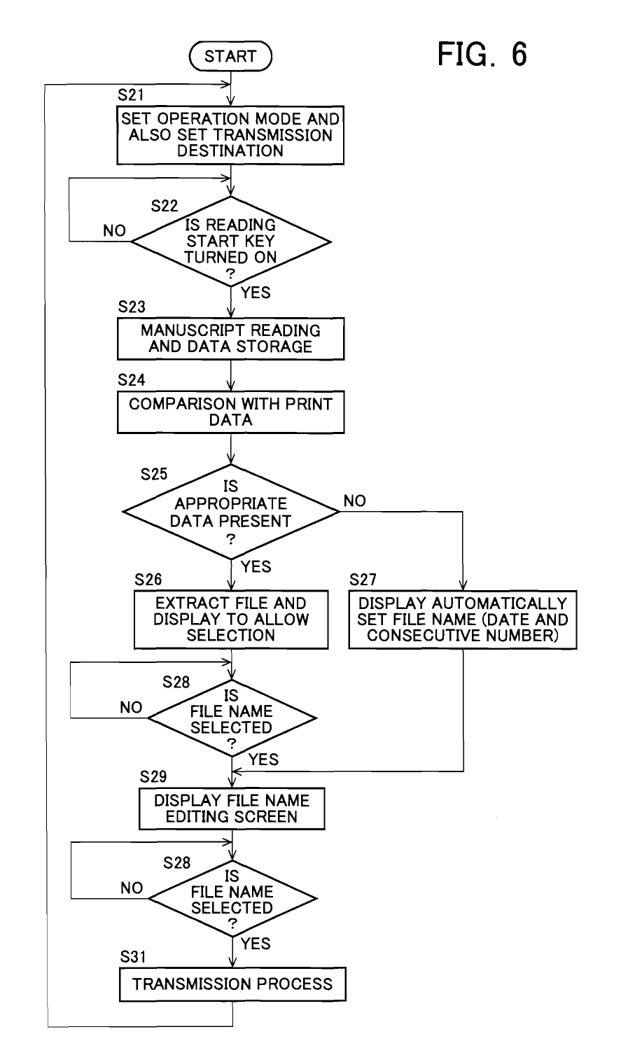

The display portion 18 displays comparison data of which a similarity level calculated by the CPU 11 is equal to or higher than the given value, together with the file name of the comparison data, to allow the user selection. For example, as shown in FIG. 7 to be described later, the display portion displays thumbnail images of the comparison data together with the file names in the order of higher similarity level calculated by the CPU 11 to allow the user selection.

When a similarity level calculated by the CPU 11 is lower than the given value, a proper file name is not present, in which case the CPU 11 may assign a consecutive number in a given format to the image data 171 as the file name thereof.

When a similarity level calculated by the CPU 11 is equal to or higher than the given value, the file name of comparison data selected by the user is displayed as the file name of the image data 171 that can be edited. When a similarity level calculated by the CPU 11 is lower than the given value, a consecutive number in the given format that is automatically assign by the MFP 10 (e.g., date plus number, etc.) is displayed as the file name of the image data 171 that can be edited. In this manner, the user is allowed to freely edit the file name of the image data 171, thus able to give a desired file name to the image data without trouble.

The method of similarity determination is not limited to the use of the fixed-form format portions as described in FIGS. 2 and 3. Similarity determination may be carried out using an image placed on the header space of a page (i.e., the image equivalent to the fixed-form format portion). If image data is determined to be a similar image, an image placed in the header space of the image data is supposed to be a similar image, too. Determination on a similar image is thus carried out based on this assumption.

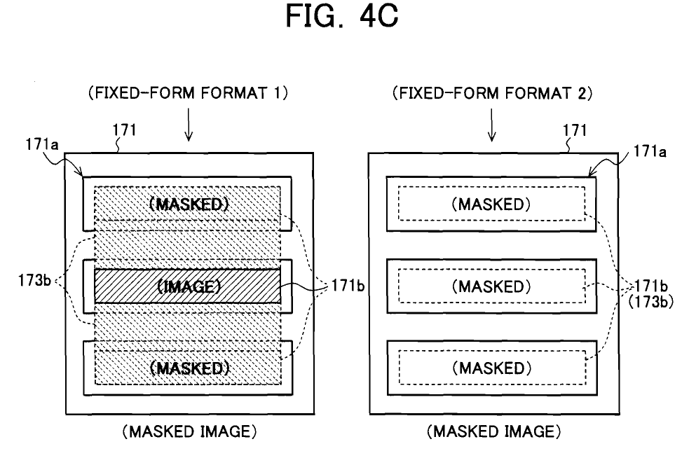

FIG. 5 is a flowchart for explaining an example of a file name giving method by the MFP 10 of the present invention. The MFP 10 sets an operation mode selected by the user, and sets a transmission destination specified by the user (step S1). Operation modes includes a scan-to-e-mail mode for transmitting image data read by the scanner 12 by e-mail and a scan-to-USB mode for transmitting image data read by the scanner 12 to a USB memory. These modes are displayed on the display portion 18 to allow the user mode selection. Transmission destination setting includes setting of the e-mail address of a transmission destination and setting of resolution. The display portion 18 displays a setting screen for inputting these setting items.

The MFP 10 then determines whether a reading start key is pressed (turned on) by the user (step S2). When the reading start key is turned on (YES), a manuscript image is read by the scanner 12, and the read image data 171 is stored in the memory portion 17 (step S3). When the reading start key is not turned on at step S2 (NO), the operation state changes over to a reading start key turning on (press) waiting state at step S2.

The MFP 10 then carries out pattern matching between the image data 171 read by the scanner 12 and the print data stored in the memory portion 17, and calculates the ratio of matching pixels as a similarity level (step S4). The MFP 10 determines whether the print data 172 having a similarity level equal to or higher than the given value is present (step S5). When the print data 172 having the similarity level equal to or higher than the given value is present (YES), the MFP 10 extracts a file of the print data 172, and displays a thumbnail image of the print data 172 together with the file name thereof (step S6). At step S5, when the print data 172 having the similarity level equal to or more than the given value is not present (NO), the MFP 10 carries out pattern matching between the image data 171 read by the scanner 12 and the fixed-form format data 173 stored in the memory portion 17, and calculate the ratio of matching pixels as a similarity level (step S9).

The MFP 10 determines whether the fixed-form format data 173 of which a similarity level calculated at step S9 is equal to or higher than the given value is present (step S10). When the fixed-form format data 173 having the similarity level equal to or higher than the given value is present (YES), the MFP 10 extracts a file of the fixed-form format data 173, and displays a thumbnail image of the fixed-form format data 173 together with the file name thereof (step S11), after which the process flow proceeds to step S7. At step S10, when the fixed-form format data 173 having the similarity level equal to or higher than the given value is not present (NO), an automatically set file name made up of a date and a consecutive number is displayed (step S12), after which the process flow proceeds to step S8.

The MFP 10 then determines whether the file name of the image data 171 is selected out of file name candidates displayed with thumbnail images on the display portion 18 (step S7). When the file name is selected out of the file name candidates (YES), the display portion 18 displays a file name editing screen on which the selected file name is set (step S8). When the file name is not selected out of the file name candidates at step S7 (NO), the operation state changes over to a file name selection waiting state at step S7.

Subsequently, the MFP 10 determines whether the file name is settled on the file name editing screen (step S13). When the file name is settled (YES), the image data 171 given the settled file name is transmitted to the transmission destination set at step S1 (step S14), after which the process flow returns to step S1 to change the operation state over to an input waiting state. When the file name is not settled at step S13 (NO), the operation state changes over to a file name settling waiting state at step S13.

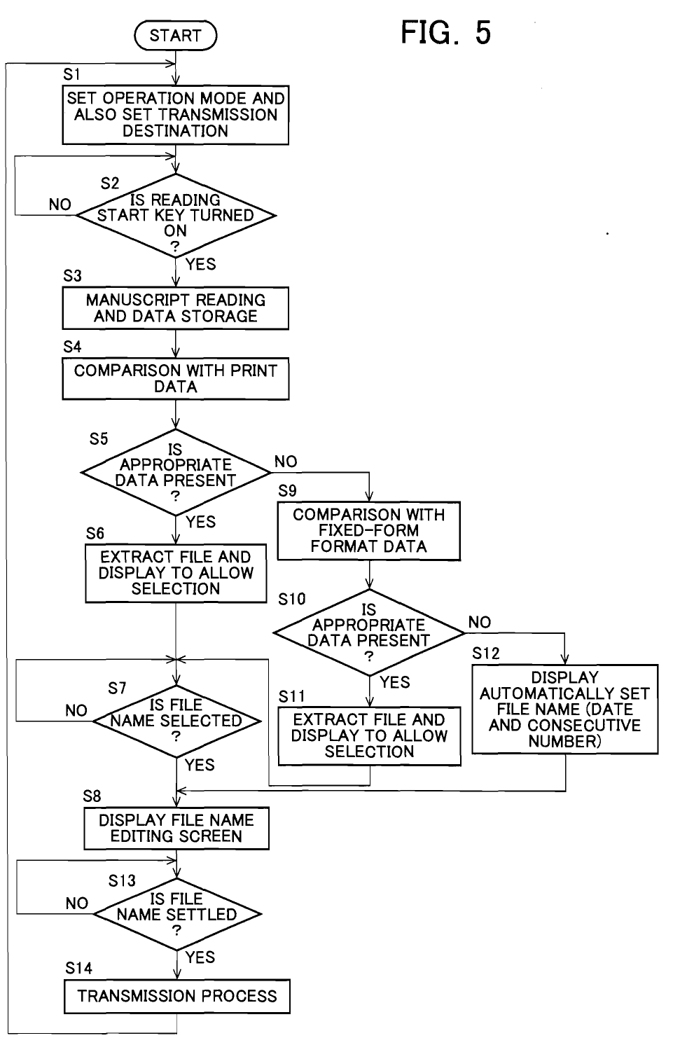

FIG. 6 is a flowchart for explaining another example of the file name giving method by the MFP 10 of the present invention. The MFP 10 sets an operation mode selected by the user, and sets a transmission destination specified by the user (step S21).

The MFP 10 then determines whether the reading start key is pressed (turned on) by the user (step S22). When the reading start key is turned on (YES), a manuscript image is read by the scanner 12, and the read image data 171 is stored in the memory portion 17 (step S23). When the reading start key is not turned on at step S22 (NO), the operation state changes over to the reading start key turning on (press) waiting state at step S22.

The MFP 10 then carries out pattern matching between the image data 171 read by the scanner 12 and the fixed-form format data 173 stored in the memory portion 17, and calculates the ratio of matching pixels as a similarity level (step S24)

The MFP 10 determines whether the fixed-form format data 173 of which the similarity level calculated at step S24 is equal to or higher than the given value is present (step S25). When the fixed-form format data 173 having the similarity level equal to or higher than the given value is present (YES), the MFP 10 extracts a file of the fixed-form format data 173, and displays a thumbnail image of the fixed-form format data 173 together with the file name thereof (step S26), after which the process flow proceeds to step S28. At step S25, when the fixed-form format data 173 having the similarity level equal to or higher than the given value is not present (NO), an automatically set file name made up of a date and a consecutive number is displayed (step S27), after which the process flow proceeds to step S29.

The MFP 10 then determines whether the file name of the image data 171 is selected out of file name candidates displayed with thumbnail images on the display portion 18 (step S28). When the file name is selected out of the file name candidates (YES), the display portion 18 displays the file name editing screen on which the selected file name is set (step S29). When the file name is not selected out of the file name candidates at step S28 (NO), the operation state changes over to the file name selection waiting state at step S28.

Subsequently, the MFP 10 determines whether the file name is settled on the file name editing screen (step S30). When the file name is settled (YES), the image data 171 given the settled file name is transmitted to the transmission destination set at step S21 (step S31), after which the process flow returns to step S21 to change the operation state over to the input waiting state. When the file name is not settled at step S30 (NO), the operation state changes over to the file name settling waiting state at step S30.

FIG. 7 depicts an example of a file name candidate display screen displayed on the display portion 18. The file name candidate display screen exhibits thumbnail images of the print data 172 or fixed-form format data 173 having a similarity level equal to or higher than the given value in the order of higher similarity level, together with file names. The user selects a desired file name out of the file names on the file name candidate display screen to set a file name for the image data 171.

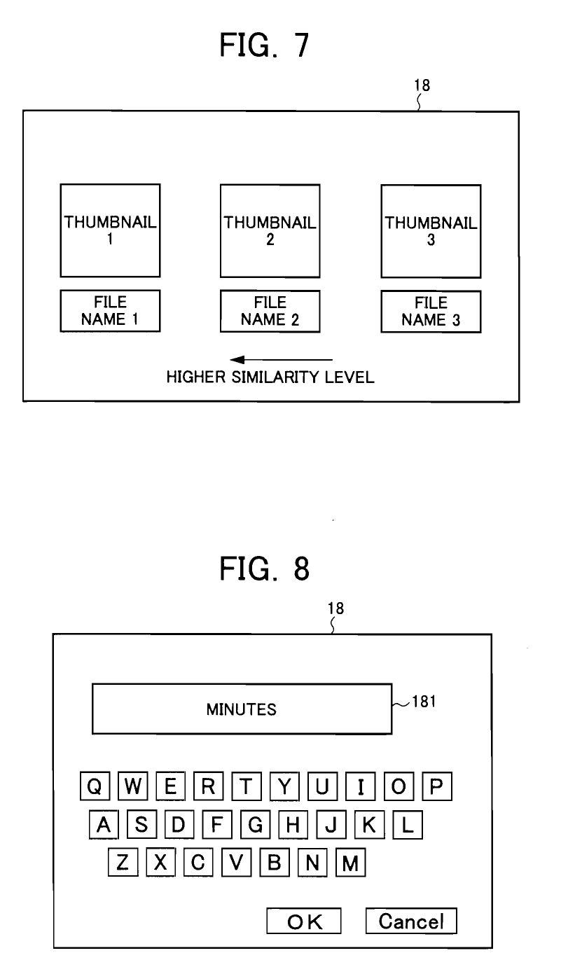

FIG. 8 depicts an example of the file name editing screen displayed on the display portion 18. A file name (“minutes”) selected and set on the file name candidate display screen of FIG. 7 is placed for display in a file name space 181 on the file name editing screen. When having no intention of editing the file name in the file name space 181, the user presses an “OK” key to settle the file name. When editing the file name, the user manipulates keyboards of FIG. 8 to edit the file name, and then presses the “OK” key to settle the file name.

The present invention offers the following effect.

According to the present invention, a proper file name is automatically given based on the similarity of image data. This eliminates a need for a user to manually input a file name, and enables the user to easily grasp the contents of image data from the file name of the image data.

1. An image data processing apparatus comprising:
an image input portion that inputs image data;
a memory portion that stores therein comparison data containing a fixed-form format portion, together with a file name corresponding to the comparison data;
a comparing portion that compares a portion equivalent to a fixed-form format portion of the comparison data contained in image data input by the image input portion, with a fixed-form format portion of comparison data stored in the memory portion; and
a file name setting portion that when the comparing portion determines the image data to be similar to the comparison data, sets a file name of the comparison data as a file name of the image data.

2. The image data processing apparatus as defined in claim 1, comprising a communication portion that communicates with an external information processing apparatus to receive comparison data including only the fixed-form format portion from the external information processing apparatus, wherein
the memory portion stores therein comparison data received by the communication portion, together with a file name of the comparison data.

3. The image data processing apparatus as defined in claim 1, comprising a communication portion that communicates with an external information processing apparatus to receive comparison data including a fixed-form format portion and a character data portion from the information processing apparatus, wherein
the memory portion stores therein comparison data received by the communication portion, together with a file name of the comparison data.

4. The image data processing apparatus as defined in claim 1, comprising a communication portion that communicates with an external memory device having stored thereon comparison data including a fixed-form format portion, wherein
the comparison data is periodically downloaded from the external memory device to update comparison data stored in the memory portion.

5. The image data processing apparatus as defined in any one of claims 1 to 4, wherein
the comparing portion compares a portion equivalent to a fixed-form format portion of the comparison data that is contained in image data input by the image input portion, with a fixed-form format portion of comparison data stored in the memory portion, and sets a similarity level representing a level of similarity between the image data and the comparison data, based on a result of the comparison.

6. The image data processing apparatus as defined in claim 5, comprising a display portion that displays various data, wherein
the display portion displays comparison data of which a similarity level calculated by the comparing portion is equal to or higher than a given value, together with a file name of the comparison data, to allow a user selection.

7. The image data processing apparatus as defined in claim 6, wherein
the display portion displays thumbnail images of the comparison data in order of higher similarity level calculated by the comparing portion, together with a file name of the comparison data, to allow a user selection.

8. The image data processing apparatus as defined in claim 5, wherein
when a similarity level calculated by the comparing portion is lower than a given value, a consecutive number in a given format is assigned as a file name to the image data.

9. The image data processing apparatus as defined in claim 6, wherein
the display portion displays a file name of the image data as a file name that can be edited.
